(19) United States
(12) Patent Application Publication
(10) Pub. No.: US 2006/0112230 A1
(43) Pub. Date: May 25, 2006

(54) Integrated memory device and memory module

(76) Inventors: Christian Sichert, Munchen (DE); Hermann Ruckerbauer, Moos (DE); Dominique Savignac, Ismaning (DE); Peter Gregorius, Munchen (DE); Paul Wallner, Prien (DE)

Correspondence Address: PATTERSON & SHERIDAN, LLP;Gero McClellan / Infineon Technologies, 3040 POST OAK BLVD.,, SUITE 1500, HOUSTON, TX, 77056, US

(21) Appl. No.: 10/996,956

(22) Filed: Nov. 24, 2004

(51) Int. Cl. G06F 13/00

(52) U.S. Cl. 711/137

(57) ABSTRACT

The present invention relates to an integrated memory device including: memory cells arranged at wordlines and bitlines, wherein the memory cells are addressable in sets of 2ⁿ bit, wherein n is an integer, a pre-fetch read unit to pre-fetch an addressed set of 2ⁿ data bit in parallel from the addressed memory area, buffer memory to buffer the number of pre-fetched data bits; a number m of output ports to output the data bits buffered in the buffer memory; an output controller for controlling the outputting of the data bits buffered in the buffer memory to the number m of output ports in groups of m bits in one or a plurality of successive cycles, characterized in that the number m of output ports is different to any of the possible numbers 2ⁿ of the sets of addressable memory cells.

### BACKGROUND OF THE INVENTION

1. Field of the Invention

The present invention relates to an integrated memory device having a number of memory cells which are addressable by an address and wherein data is prefetched in sets of 2ⁿ bit. The present invention further relates to a memory module having a plurality of memory devices.

2. Description of the Related Art

In DDR (Double Data Rate) memory devices, data in memory cells is conventionally addressable by an address in sets of 2ⁿ bit or multiples thereof. Each set of bits addressed by the address is pre-fetched in a pre-fetch buffer when retrieving data from the memory cells. Once the data from the addressed memory area is held in the pre-fetch buffer, the data is usually output in a sequence of successive cycles via output ports, in a so-called data burst. The data is output according to the Double Data Rate technology with rising and falling edges of a clock signal and the number of output cycles depends on the number of output ports used for the respective memory device. For example, with a pre-fetch size of 128 bit and the memory device having 16 output ports, the buffered data can be output in 8 successive cycles.

In an advanced DDR-3 technology, the bit rate for outputting data at the output ports corresponds to 1.6 Gbit per second. When switching to a more advanced technology data net generation, like e.g. DDR-4, normally the bit rates are doubled so that data would be output with a bit rate of 3.2 Gbit per second at the output ports. Using single-ended data signaling at this bit rate is difficult in view of technical and design aspects. In order to overcome these difficulties, most probably a switch-over to differential signaling will take place which has the drawback that the pin count of the data ports will be doubled having impacts on the reliability and the cost of manufacturing of such devices. Reducing the count of the data ports would mean that the bit rates be doubled again which results in 6.4 Gbit per second per pin in DDR-4. However, this high bit rate cannot be handled in technological aspects, neither by the data port of the memory device nor by the bus channels and the memory controller so that either an increased pin count or an increased bit rate has to be accepted with the above-mentioned approaches in DDR-4.

The same problem mentioned for the memory devices exists for the memory modules on which a plurality of memory devices are attached.

### SUMMARY OF THE INVENTION

One aspect of the present invention provides a memory device which can handle increased bit rates with a minimized pin count.

A further aspect of the present invention provides a memory module which is adapted to operate memory devices to provide an increased bit rate with a minimized pin count.

According to a further aspect of the present invention, an integrated memory device is provided which includes memory cells arranged on wordlines and bitlines wherein the memory cells are addressable by an address in sets of 2ⁿ bits wherein n is an integer. Furthermore, a pre-fetch read unit is provided to pre-fetch an addressed set of 2ⁿ data bits in parallel from an addressed memory area, and a buffer memory is provided to buffer the number of pre-fetch data bits. The memory device furthermore includes a number m of output ports to output the data bits buffered in the buffer memory, and the number m of output ports is controlled by an output controller. The outputting of the data bits is performed in groups of n bits in one or a plurality of successive cycles. The number m of output ports is different from any of the possible numbers 2ⁿ of the sets of addressable memory cells or multiples thereof.

According to another aspect of the invention, memory cells arranged at the wordlines and bitlines are grouped so that they are addressable in sets of bits, each set including a number k of bits wherein the number k is different from a number 2ⁿ, wherein n is an integer. Furthermore, a pre-fetch read unit, a buffer memory and a number m of output ports is provided, each designed as mentioned above. The number m of output ports equals the number k of pre-fetched data bits.

According to another aspect of the present invention, an output controller controls the outputting of the data bits to form the number m of output ports in groups of m bits in a plurality of successive cycles, wherein the number k of pre-fetched data bits is equal or lower than a multiple of the number m of output ports.

According to another aspect of the present invention, the number m of output ports equals one of 5, 6 and 7 or is any multiple of the one of 5, 6 and 7.

According to a further aspect of the present invention, memory modules are provided including a number of memory devices. The memory module has a data interface for transmitting in a parallel form a number of bits read out of the memory devices. The data interface comprises a number j of data output ports which is different from a number 2ⁿ, wherein n is an integer.

According to another aspect of the present invention, a memory module is provided including a number of such memory devices wherein the data interface comprises a number j of data output ports which is different from a number 2ⁿ, wherein n is an integer.

According to a preferred embodiment of the present invention, the output ports of any of the above mentioned memory devices are designed as differential output ports each having two differential signal lines.

Furthermore, it may be provided that the memory device is designed as a Double Data Rate memory device.

According to a preferred embodiment of the memory module, the module comprises a number of memory devices which equals the number j of output ports of the data interface divided by the number m of data output ports of each memory device.

According to another embodiment of the present invention, the memory module comprises one of the numbers 42, 48 and 54 of output ports.

### BRIEF DESCRIPTION OF THE DRAWINGS

A preferred embodiment of the present invention will be described in detail in the following description with respect to the accompanying drawings, in which:

FIG. 1 shows a block diagram of an integrated memory device according to a preferred embodiment of the present invention;

FIG. 2 schematically shows a memory module having a number of memory devices according to another embodiment of the present invention; and

FIG. 3 schematically shows a further embodiment of a memory module of the present invention.

### DETAILED DESCRIPTION OF THE PREFERRED EMBODIMENT

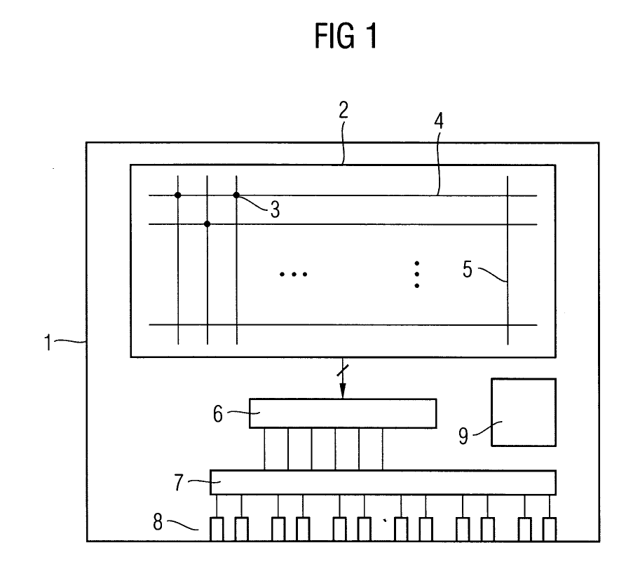

FIG. 1 shows a memory device 1 including a memory array 2. The memory array comprises memory cells 3 arranged on wordlines 4 and bitlines 5. For example the memory cells can be DRAM memory cells, SRAM cells and the like.

The memory device 1 is designed e.g. as a Double Data Rate memory device from which data can be read out in a burst access which means that by applying an address to the memory array 2, a number of data bits is internally provided for outputting in groups of a number of parallel data bits in a number of successive cycles.

This is e.g. achieved by simultaneously addressing a plurality of memory areas (banks etc.) which provide data to be read out from the addressed memory cells 3 and forward the read-out data to a pre-fetch buffer 6 wherein the data is latched until it is forwarded to output via a number of output ports 8. The pre-fetch is performed by the pre-fetch read unit 9.

In conventional memory devices, the number of pre-fetched data bits corresponds to 2ⁿ wherein n is an integer, or a multiple thereof. This is a result of the internal organization of the memory array and the binary operating logic associated therewith. The number of pre-fetched data is meant to exclude additional data retrieved from a reserved memory space, which is used to correct errors in the data read out from the memory cells. Pre-fetched data, as used herein, is to be understood as data and to be read out of the memory and to be provided as application data in a data processing system. Furthermore, it is usually provided that the number m of data output ports 8 of the memory device 1 is equal to a number n which is normally defined by the number of pre-fetched data bits divided by the number of successive cycles in a burst access.

While in conventional memory devices, the above described architecture is always used due to the binary operating logic as e.g. multiplexers, demultiplexers, switches and the like, the memory device according to the present invention departs from this approach and it is proposed to reduce the number of data output ports 8 to a number m which is different from a number 2ⁿ wherein n is an integer.

To increase the bit rate for outputting data via the output ports 8, the output ports 8 are preferably designed as differential output ports wherein the data is transferred via two differential signal lines. However, this has the disadvantage, that the number of data pins of the memory device 1 is doubled thereby increasing the overall pin count of the memory device 1. Moreover, when the bit rate is doubled at the transition to a next Double Data Rate technology the bit rate would reach 3.2 Gbit per second. To maintain the overall bit rate of data with which data can be transferred from the memory device 1, the bit rate has to be further increased when the overall pin count of the data output ports 8 is reduced to limit the pin count of the memory device 1. The possibility to double the bit rate to 6.4 Gbit per second and to half the number of data output ports of the memory device is technically difficult to realize as the bit rate requires high frequencies which makes the design of the memory device as well as of the bus channels and the memory controller difficult. Further, increasing the bit rate to 6.4 Gbit would allow for outputting 64 bit×128 bit (pre-fetched data) in a time less than 5 ns so that a time gap exists in which no data can be output until the beginning of the next burst.

The proposed approach of the present invention is to choose a number of data output ports 8 which is between the number of output ports used in a former conventional Double Data Rate technology, e.g. in a conventional DDR-3 technology, and to decrease this number not to half of the number of output ports but to a number which is somewhere in between the half and the number of output ports of the former Double Data Rate technology, when switching to a more advanced Double Data Rate technology. When switching to differential signaling the overall pin count is increased by not as much as would be the case where the number of output ports is not decreased. For example, if the DDR-3 technology has a number of 16 data output ports, the number of data output ports can be reduced to e.g. 12 instead of reducing it to the number of 8 (when introducing differential signaling, to maintain the pin count). As the number of bits pre-fetched in the pre-fetch buffer 6 should usually not be changed when switching to the new Double Data Rate technology (to be able to maintain internal design schemes), reducing the number of data output ports to a number other than the half would require increasing the bit rate depending on and corresponding to the reduction of the number of data output ports.

The following table (TABLE) shows the relation between a predicted DDR-4 memory device having 8 data output ports, a bit burst length of 16 and different bit rates per output port of 3.2 Gbit per second 4.266 Gbit/s and 4.8 Gbit/s wherein 128 bit data are pre-fetched and are to be transmitted within one burst access. The TABLE indicates the maximum amount of data which can be output in the burst access in the respective configuration. The TABLE also indicates that the number of data output ports can be reduced to any number which is between the number of data output ports of the memory device of the former double data rate technology and the half of the number of data output ports and which is different from the number 2ⁿ, wherein n is an integer, or a multiple thereof. The difference in the number of bits between the maximum amount of burst data and the pre-fetched data can be used for synchronization and error correction purposes.

TABLE

| Bit rate | Burst length | maximum amount of burst data |
|---|---|---|
| 3.2 Gbit/s | 16 | 128 |
| 4.266 Gbit/s | 22 | 132 |
| 4.8 Gbit/s | 22 | 132 |

The memory device 1 of FIG. 1 is a memory device wherein the internal design is substantially identical to the design of a conventional memory device, however, the pre-fetch buffer can be controlled by an output controller 7 in such a way that a group of data bits is output in parallel wherein the number of data bits of the group is different from 2ⁿ or a multiple thereof and corresponds to the number m of output ports.

In order to adapt the number of pre-fetched data bits to the adapted number of data output ports, the internal structure of the memory device 1 can be changed according to another embodiment of the present invention so that the number of pre-fetched data bits is a multiple of the number m of data output ports 8 provided in the memory device 1 so that the last group of data bits output in the cycles of the burst does not include empty spaces in which no data is contained.

In a preferred embodiment of the present invention, the number of data output ports is selected from one of the numbers 5, 6, 7 and multiples of 5, 6, 7. However, other numbers which are different from 2ⁿ (wherein n is an integer) or a multiple thereof can be chosen, e.g., 13 or 15.

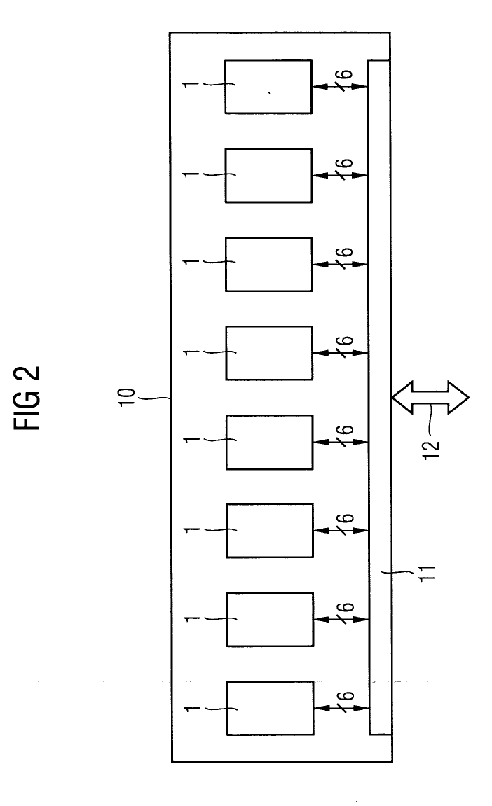

According to another embodiment of the present invention, a memory module 10 is provided which has a reduced bus width as shown in FIG. 2. The memory module 10 includes a number of memory devices 1 which are coupled to a data bus 12 via the data interface 11 and which comprises a number j of data ports via which data can be transmitted to and from the memory devices 1. Usually, in memory modules 10 the number j of data ports equals 2ⁿ or a multiple thereof as the included memory devices also usually comprise a number of data output ports the number of which equals 2ⁿ or multiples thereof. Using memory devices 10 different thereof such as memory devices mentioned above and having a different number j of output ports, a different bus width can be achieved. For example, the number of data ports of the data interface 11 of the memory module 10 equals one of 42, 48 and 54 bit based on the number of output ports of the memory devices provided thereon. In the shown example each memory device includes 6 output ports and the memory module 10 comprises 48 data ports.

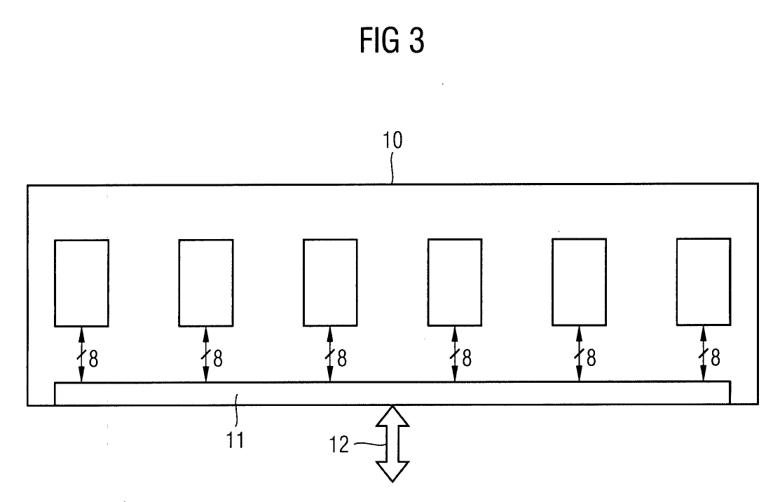

Another possibility to decrease the number of data outputs of the data interface of the memory module is to reduce the number of memory devices 1 on the memory module 10 itself from 2ⁿ (wherein n is an integer) or a multiple thereof, to a different number, e.g. to one of 5, 6, 7, as shown in FIG. 3. It is noted that reference is made to memory modules without counting one or more error correction memory devices (ECC) which can be provided and which would increase the number of memory devices on the memory module by one or more. An optionally provided additional memory device is not meant to be counted as the number of memory devices operable for supplying relevant data.

By reducing the number of memory devices 1 on the memory module, the amount of bits transferred by burst access is reduced correspondingly, so that a data bus of 40, 48 or 56 bit can be obtained. This will reduce the pin count at the memory controller (not shown) and the data interface 11 of the memory module. As the data ports of the memory module, the multiple of the number of data output ports of the memory devices using memory device having a number of data output ports different from 2ⁿ and multiples thereof will result in a number of data ports of the data interface which is different compared to the embodiment of the memory module mentioned before. For example, using memory devices 1 having a number 6 of data output ports, a bus width of 42, 48 or 54 bit can be achieved (or other multiples of 6) which allows selection of the bit rate and the parallelism of data transfer (number of output ports) from a broad range of different alternatives, so that it can be chosen depending on the suitable technology used.

While the foregoing is directed to embodiments of the present invention, other and further embodiments of the invention may be devised without departing from the basic scope thereof, and the scope thereof is determined by the claims that follow.

What is claimed is:

1. An integrated memory device, comprising:
a plurality of memory cells arranged at wordlines and bitlines; wherein the memory cells are addressable in sets of 2ⁿ bits, wherein n is an integer;
a pre-fetch read unit to pre-fetch an addressed set of 2ⁿ data bits in parallel from the memory cells;
a buffer memory to buffer the number of pre-fetched data bits;
a number m of output ports to output the data bits buffered in the buffer memory; and
an output controller for controlling the outputting of the data bits buffered in the buffer memory to the number m of output ports in groups of m bits in one or more successive cycles; wherein the number m of output ports is different than any of the possible numbers 2ⁿ, or multiples thereof, of data bits in the addressed set.

2. The memory device of claim 1 wherein the output ports are differential output ports each having two differential signal lines.

3. The memory device of claim 1 wherein the memory device is a double data rate (DDR) memory device.

4. An integrated memory device, comprising:
a plurality of memory cells arranged at wordlines and bitlines, wherein the memory cells are addressable in sets of bits, each set including k bits wherein the number k is different from a number 2ⁿ, wherein n is an integer;
a prefetch read unit to prefetch an addressed set of k data bits in parallel from addressed memory cells;
a buffer memory to buffer the k prefetched data bits;
a number m of output ports to output the data bits buffered in the buffer memory; and
an output controller for controlling the outputting of the data bits buffered in the buffer memory to the number m of output ports in groups of m bits in one or more successive cycles; wherein the number m of output ports equals the number k of prefetched data bits.

5. The memory device of claim 4 wherein the output ports are differential output ports each having two differential signal lines.

6. The memory device of claim 4 wherein the memory device is a DDR memory device.

7. An integrated memory device, comprising:
a plurality of memory cells arranged at wordlines and bitlines, wherein the memory cells are addressable in sets of bits, each set including a number k of bits wherein the number k is different from a number 2ⁿ, wherein n is an integer;
a prefetch read unit to prefetch an addressed set of data bit in parallel from addressed memory cells;
a buffer memory to buffer the number k of prefetched data bits;
a number m of output ports to output the data bits buffered in the buffer memory; and
an output controller for controlling the outputting of the data bits buffered in the buffer memory to the number m of output ports in groups of m bits in one or more successive cycles; wherein the number k of prefetched data bits is a multiple of the number m of output ports.

8. The memory device of claim 7 wherein the output ports are differential output ports each having two differential signal lines.

9. The memory device of claim 7 wherein the memory device is a DDR memory device.

10. An integrated memory device, comprising:
a plurality of memory cells arranged at wordlines and bitlines, wherein the memory cells are addressable in sets of 2ⁿ bit, wherein n is an integer;
a prefetch read unit to prefetch an addressed set of 2ⁿ data bit in parallel from addressed memory cells;
a buffer memory to buffer the number of prefetched data bits;
a number m of output ports to output the data bits buffered in the buffer memory; and
an output controller for controlling the outputting of the data bits buffered in the buffer memory to the number m of output ports in groups of m bits in one or more successive cycles; wherein the number m of output ports is one of 5, 6, 7 and any multiple of one of 5, 6 and 7.

11. The memory device of claim 10 wherein the output ports are differential output ports each having two differential signal lines.

12. The memory device of claim 10 wherein the memory device is a DDR memory device.

13. A memory module, comprising:
(a) a plurality of memory devices each comprising:
a plurality of memory cells arranged at wordlines and bitlines; wherein the memory cells are addressable in sets of 2ⁿ bits, wherein n is an integer;
a pre-fetch read unit to pre-fetch an addressed set of 2ⁿ data bits in parallel from the memory cells;
a buffer memory to buffer the number of pre-fetched data bits;
a number m of output ports to output the data bits buffered in the buffer memory; and
an output controller for controlling the outputting of the data bits buffered in the buffer memory to the number m of output ports in groups of m bits in one or more successive cycles; wherein the number m of output ports is at least one of:
different than any of the possible numbers 2ⁿ, or multiples thereof, of data bits in the addressed set; and
5, 6, 7 and any multiple of one of 5, 6 and 7; and
(b) a data interface for transmitting in a parallel form a number of bits read out of the memory devices; wherein the data interface comprises a number j of data output ports which is different from the number 2ⁿ.

14. The memory module of claim 13, wherein a number of memory devices equals the number j of output ports of the data interface divided by the number m of data output ports of each memory device.

15. The memory module of claim 13, wherein the module comprises 42, 48 or 54 output ports.

16. The memory module of claim 13, wherein the output ports of the module are differential output ports.

17. The memory module of claim 13, wherein the memory devices are DDR memory devices.

18. A memory module, comprising:
(a) a number of memory devices each comprising:
a plurality of memory cells arranged at wordlines and bitlines, wherein the memory cells are addressable in sets of bits, each set including k bits wherein the number k is different from a number 2ⁿ, wherein n is an integer;
a prefetch read unit to prefetch an addressed set of k data bits in parallel from addressed memory cells;
a buffer memory to buffer the k prefetched data bits;
a number m of output ports to output the data bits buffered in the buffer memory; and
an output controller for controlling the outputting of the data bits buffered in the buffer memory to the number m of output ports in groups of m bits in one or more successive cycles; wherein the number m of output ports is at least one of:
equal to the number k of prefetched data bits; and
a multiple of the number m of output ports; and
(b) a data interface for transmitting in a parallel form a number of bits read out of the memory devices, wherein the data interface comprises a number j of data output ports which is different from the number 2ⁿ.

19. The memory module of claim 18, wherein a number of the memory devices which equals the number j of output ports of the data interface divided by the number m of data output ports of each memory device.

20. The memory module of claim 18, wherein the module comprises 42, 48 or 54 output ports.

21. The memory module of claim 18, wherein the output ports of the module are differential output ports.

22. The memory module of claim 18, wherein the memory devices are DDR memory devices.
